(19) United States
(12) Patent Application Publication
(10) Pub. No.: US 2026/0079351 A1
(43) Pub. Date: Mar. 19, 2026

(54) WEARABLE ELECTRONIC DEVICE COMPRISING DISPLAY

(71) Applicant: SAMSUNG ELECTRONICS CO., LTD., Suwon-si (KR)

(72) Inventors: Doukyoung SONG, Suwon-si (KR); Youngran KIM, Suwon-si (KR); Hyunsoo KIM, Suwon-si (KR)

(73) Assignee: SAMSUNG ELECTRONICS CO., LTD., Suwon-si (KR)

(21) Appl. No.: 19/400,568

(22) Filed: Nov. 25, 2025

Related U.S. Application Data
(63) Continuation of application No. PCT/KR2024/007106, filed on May 24, 2024.

(30) Foreign Application Priority Data
May 25, 2023 (KR) 10-2023-0067910
Nov. 24, 2023 (KR) 10-2023-0165824

(51) Int. Cl. G02B 27/01; G02B 3/00

(52) U.S. Cl. CPC G02B 27/0172; G02B 3/0037; G02B 27/0176; G02B 2027/0116; G02B 2027/0161

(57) ABSTRACT

A wearable electronic device includes: a first display including a first display panel and a first optical assembly on one surface of the first display panel; and a first lens configured to transmit light output from the first display to the eyes of a user. The center of the first lens may be spaced apart from the center of the first display by a specified distance in a first direction. The first display panel includes first pixels continuously arranged on the same plane, and chief ray angles with respect to the optical axis of the first lens may be changed to correspond to the first pixels. The first optical assembly may include first microlenses configured to change paths of light output from the first pixels by a compensation angle and transmit the light to the first lens.

### CROSS-REFERENCE TO RELATED APPLICATIONS

This application a continuation of International Application No. PCT/KR2024/007106, filed on May 24, 2024, which is based on and claims priority to Korean Patent Application No. 10-2023-0067910, filed on May 25, 2023, and Korean Patent Application No. 10-2023-0165824, filed on Nov. 24, 2023, in the Korean Intellectual Property Office, the disclosures of which are incorporated by reference herein in their entireties.

### BACKGROUND

### 1. Field

The disclosure relates to a wearable electronic device including a display.

### 2. Description of Related Art

Portable electronic devices, such as electronic schedulers, portable multimedia players, mobile communication terminals, or tablet personal computers (PCs), are generally equipped with a display member and a battery, and come in bar, clamshell, or slidable shape by the shape of the display member or battery. As display members and batteries are nowadays made smaller and have enhanced performance, wearable electronic device which may be put on the user's wrist, head, or other body portions are commercially available. Wearable electronic devices may be directly worn on the human body, presenting better portability and user accessibility.

Wearable electronic devices may include electronic devices wearable on the user's face, such as head-mounted devices (HMDs). The head-mounted device may be usefully used to implement virtual reality or augmented reality. For example, a wearable electronic device may provide a virtual image, such as an image of a virtual space in a game that was enjoyed through a television or computer monitor, and may implement virtual reality by blocking an image of a user's surrounding environment. For example, a wearable electronic device may implement augmented reality that provides various visual information to a user by providing both an image of the user's surrounding environment and a virtual image.

The above-described information may be provided as related art for the purpose of helping understanding of the disclosure. No claim or determination is made as to whether any of the foregoing is applicable as background art in relation to the disclosure.

### SUMMARY

According to an embodiment of the disclosure, a wearable electronic device may be provided. The wearable electronic device may include a first display including a first display panel and a first optical assembly on a surface of the first display panel, and a first lens configured to transmit light output from the first display to eyes of a user. The center of the first lens may be spaced apart from the center of the first display in a first direction by a designated interval. The first display panel includes first pixels continuously disposed on a same plane, and chief ray angles with respect to an optical axis of the first lens may change corresponding to the first pixels. The first optical assembly may include first micro-lenses configured to change paths of light output from the first pixels by compensation angles to provide the light output from the first pixels to the first lens. Difference values between first error amounts, which are differences between the chief ray angles and the compensation angles in a first edge area of the first display located in the first direction, and second error amounts, which are differences between the chief ray angles and the compensation angles in a second edge area of the first display located in a second direction opposite to the first direction, may be set to be included within a first designated angle range.

According to an embodiment of the disclosure, a display assembly may be provided. The display assembly may include a display panel including pixels continuously disposed on a same plane, wherein chief ray angles with respect to an optical axis of the lens change according to positions of the pixels. The display assembly may include an optical assembly stacked on a surface of the display panel and a lens configured to transmit light transmitted through the display panel and the optical assembly to eyes of a user. The center of the lens may be spaced apart from the center of the display panel in a first direction by a designated interval. The optical assembly may include micro-lenses configured to change paths of light output from the pixels by compensation angles to provide the light output from the pixels to the lens. Difference values between first error amounts, which are differences between the chief ray angles and the compensation angles in a first edge area of the display located in the first direction, and second error amounts, which are differences between the chief ray angles and the compensation angles in a second edge area of the display located in a second direction opposite to the first direction, may be set to be included within a first designated angle range.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating a wearable electronic device according to an embodiment of the disclosure;

FIGS. 3A and 3B are views illustrating front and rear surfaces of a wearable electronic device according to an embodiment of the disclosure;

FIG. 4A is a schematic plan view illustrating arrangement of a display and a lens of a display assembly according to an embodiment of the disclosure;

FIG. 4B is a schematic side view illustrating an arrangement relationship between a display and a lens and a movement path of light according to an embodiment of the disclosure;

FIG. 4C is a schematic cross-sectional side view illustrating an arrangement relationship between a display and a lens and a movement path of light according to an embodiment of the disclosure;

FIG. 4D is a simulation image of a field of view provided by the display assembly of FIGS. 4A to 4C according to an embodiment of the disclosure;

FIG. 5A is a schematic plan view illustrating arrangement of a display and a lens of a display assembly according to an embodiment of the disclosure;

FIG. 5B is a schematic cross-sectional side view illustrating an arrangement relationship between a display and a lens and a movement path of light according to an embodiment of the disclosure;

FIG. 5C is a simulation image of a field of view provided by the display assembly of FIGS. 5A and 5B according to an embodiment of the disclosure;

FIG. 6 is a schematic plan view illustrating arrangement of a display and a lens of a display assembly according to an embodiment of the disclosure;

FIG. 7 is a schematic side view illustrating an arrangement relationship between a display and a lens and a movement path of light according to an embodiment of the disclosure;

FIG. 8 is a schematic cross-sectional side view illustrating an arrangement relationship between a display and a lens and a movement path of light according to an embodiment of the disclosure;

FIG. 9 is a simulation image of a field of view provided by the display assembly of FIGS. 6 to 8 according to an embodiment of the disclosure;

FIG. 10 is a graph illustrating changes in chief ray angles and compensation angles of a display assembly according to an embodiment of the disclosure;

FIG. 11 is a graph illustrating changes in error amounts between chief ray angles and compensation angles of a display assembly according to an embodiment of the disclosure; and

### DETAILED DESCRIPTION

The following description taken in conjunction with the accompanying drawings is provided to aid a comprehensive understanding of various embodiments of the disclosure as defined by the claims and equivalents thereto. The following description may include various specific details to aid understanding, but these may be considered exemplary only. Hence, it should be appreciated by one of ordinary skill in the art that various changes or modifications may be made to the embodiments without departing from the spirit or scope of the present disclosure. Descriptions of well-known functions and configurations may be omitted for clarity and conciseness.

Throughout the drawings, like reference numerals may be assigned to like parts, components, and/or structures.

The terms and words used in the following description and claims are not limited to the dictionary meaning, but are used only to enable a clear and consistent understanding of the disclosure. Accordingly, it will be apparent to one of ordinary skill in the art that the following description of various embodiments of the disclosure is provided by way of example only and not to limit the disclosure as defined by the appended claims and equivalents thereof.

As used herein, the singular forms “a,” “an,” and “the” are intended to include the plural forms as well, unless the context clearly indicates otherwise. For example, when a “surface” of a component is mentioned, it may mean one or more of surfaces of the component.

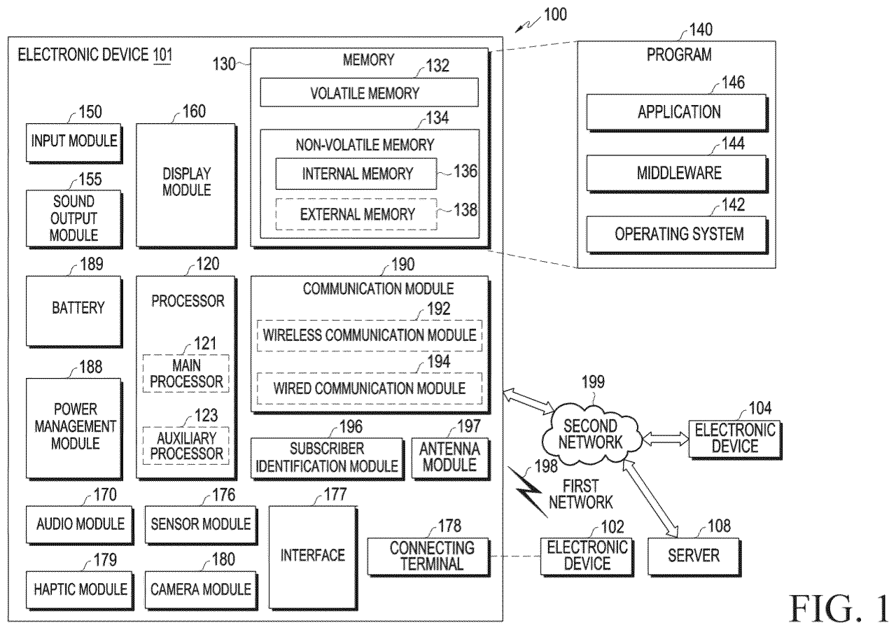

FIG. 1 is a block diagram illustrating an electronic device in a network environment according to an embodiment of the disclosure.

Referring to FIG. 1, the electronic device (or wearable electronic device) in the network environment 100 may communicate with an external electronic device 102 via a first network 198 (e.g., a short-range wireless communication network), or an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a second sensor module configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., external electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (CD) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

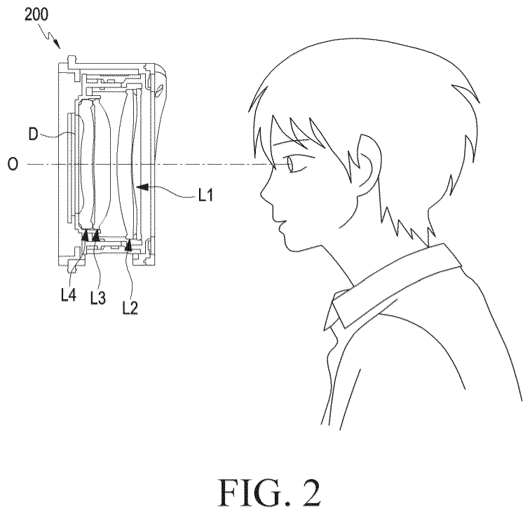

FIG. 2 is a view illustrating a wearable electronic device 200 according to an embodiment of the disclosure.

Although some numbers are presented in describing an embodiment of the disclosure, it should be noted that the numbers do not limit the embodiment of the disclosure as long as the numbers are not set forth in the claims.

Referring to FIG. 2, the wearable electronic device 200 (e.g., an electronic device 101 of FIG. 1) may be an electronic device that may be worn on the user's head or face, and the user may visually recognize the surrounding objects or environment even while wearing the wearable electronic device 200. The wearable electronic device 200 may obtain and/or recognize a visual image regarding the environment or an object in the direction in which the wearable electronic device 200 is oriented or the user views using the camera module and receive information about the object or environment from an external electronic device through a network. The wearable electronic device 200 may provide the received object- or environment-related information, in the form of an audio or visual form, to the user. For example, the wearable electronic device 200 may provide the received object- or environment-related information, in a visual form, to the user through a display member such as a display module. By implementing information about the object or environment in a visual form and combining them with a real image (or video) of the user's ambient environment, the wearable electronic device 200 may implement augmented reality (AR), virtual reality (VR), mixed Reality (MR), and/or extended reality (XR). The display member may output a screen in which the augmented reality object is added to the actual image (or video) of the environment around the user, thereby providing information regarding the surrounding thing or environment to the user.

According to an embodiment, all or some of operations to be executed at the electronic device 101 or wearable electronic device 200 may be executed at one or more of the external electronic devices 102, 104, or 108. For example, if the electronic device 101 or wearable electronic device 200 should perform a function or a service automatically, or in response to a request from a user or another device, the electronic device 101 or wearable electronic device 200, instead of, or in addition to, executing the function or the service, may request the one or more external electronic devices 102, 104, or 108 to perform at least part of the function or the service. The one or more external electronic devices receiving the request may perform the at least part of the function or the service requested, or an additional function or an additional service related to the request, and transfer an outcome of the performing to the electronic device 101 or wearable electronic device 200. The electronic device 101 or wearable electronic device 200 may provide the outcome, with or without further processing of the outcome, as at least part of a reply to the request. For example, the external electronic device 102 may render and transfer, to the electronic device 101 or wearable electronic device 200, content data executed on an application, and the electronic device 101 or wearable electronic device 200 receiving the data may output the content data to a display module. When the electronic device 101 or wearable electronic device 200 detects the user's movement through a sensor(s) such as an inertial measurement unit sensor including a gyro sensor, an acceleration sensor, and/or a geomagnetic sensor, the processor (e.g., the processor 120 of FIG. 1) of the electronic device 101 or wearable electronic device 200 may correct the rendering data received from the external electronic device 102 based on the movement information and output the same on the display module. Alternatively, when detecting the user's movement through the sensor(s), the processor (e.g., the processor 120 of FIG. 1) of the electronic device 101 or wearable electronic device 200 may transfer the movement information to the external electronic device 102, rendering to update the screen data. According to various embodiments, the external electronic device 102 may be various types of devices, such as a case device capable of storing and charging the electronic device 101.

In the following detailed description, the “state or position in which the electronic device or a designated component of the electronic device faces the user's face” may be mentioned in various manners and it should be noted that this presumes that the user wears the wearable electronic device 200.

According to an embodiment, the wearable electronic device 200 may include at least one display member and a wearing member. Depending on the structure of the display member, the wearable electronic device 200 may further include a structure (e.g., lens frame) for mounting or supporting the display member. A pair of display members including a first display member and a second display member may be provided and be disposed to correspond to the user's right and left eyes, respectively, while the wearable electronic device 200 is worn on the user's body. In an embodiment, the wearable electronic device 200 may have a housing shape (e.g., goggles shape) including one display member corresponding to the right eye and the left eye.

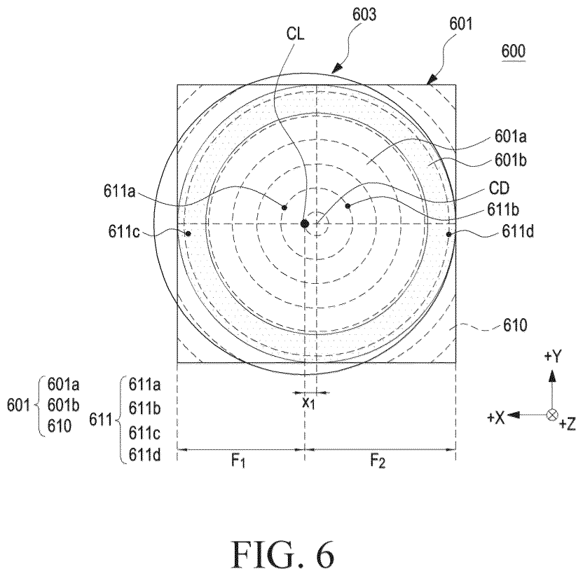

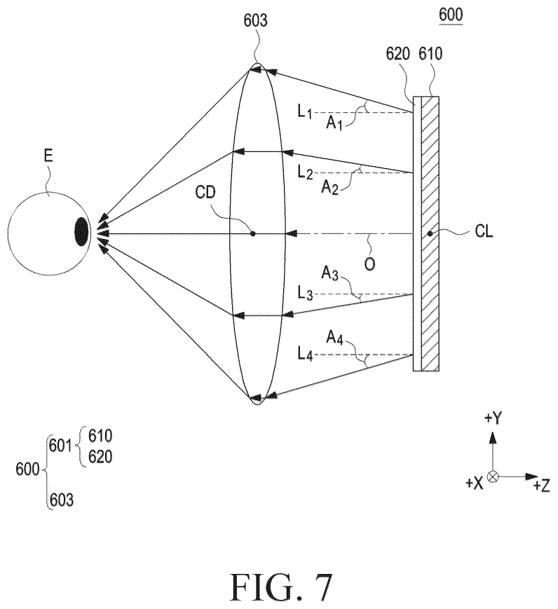

According to an embodiment, the display member is a component provided to provide visual information to the user and may include, e.g., a display D, a plurality of lenses L1, L2, L3, and L4 (e.g., a lens assembly), and/or at least one sensor. Here, the lens assembly and the display D each may be formed to be transparent or semi-transparent. However, the display member is not limited thereto. In an embodiment, the display member may include a window member that may be a semi-transparent glass or a member capable of adjusting its light transmittance depending on the concentration of coloring. In an embodiment, the display member may include a reflective lens or a lens including a waveguide. An image output from the light output device (e.g., a projector or display D) may be formed on each lens, providing the user with visual information. For example, the display member may mean a display that may include a waveguide (e.g., a light waveguide) in at least a portion of each lens and transfer the image (or light) output from the light output device, such as the display D, through the waveguide included in the display member to the user's eye while simultaneously transferring the real world through the area to the user's eye in a see-through fashion. In an embodiment, the waveguide may be understood as a portion of a lens assembly. The lens assembly (e.g., the lens 603 of FIGS. 6 and 7) is a component including a plurality of lenses (e.g., L1, L2, L3, and L4) and may be disposed to be aligned with the optical axis (e.g., the optical axis O of FIG. 7) in the space inside the wearable electronic device 200.

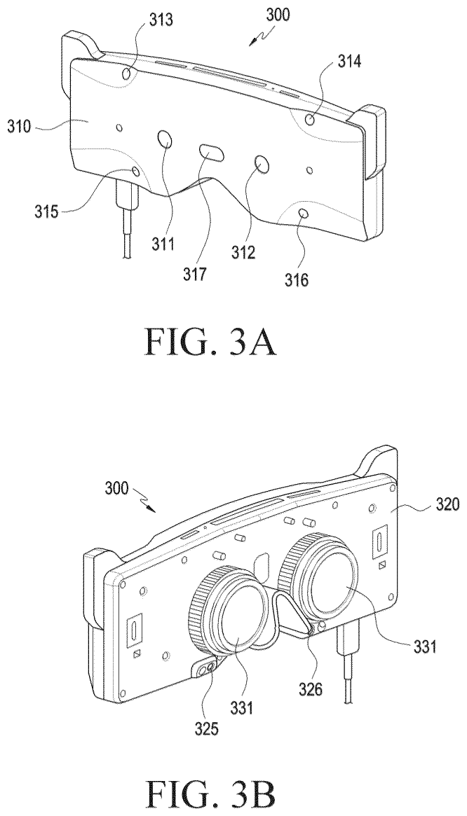

FIGS. 3A and 3B are views illustrating front and rear surfaces of a wearable electronic device 300 according to an embodiment.

Referring to FIGS. 3A and 3B, in an embodiment, camera modules 311, 312, 313, 314, 315, and 316 and/or a depth sensor 317 for obtaining information related to the ambient environment of the wearable electronic device 300 may be disposed on the first surface 310 of the electronic device 300 (e.g., the housing).

In an embodiment, the camera modules 311 and 312 may obtain images related to the ambient environment of the wearable electronic device.

In an embodiment, the camera modules 313, 314, 315, and 316 may obtain images while the wearable electronic device is worn by the user. The camera modules 313, 314, 315, and 316 may be used for hand detection, tracking, and recognition of the user gesture (e.g., hand motion). The camera modules 313, 314, 315, and 316 may be used for 3 degrees of freedom (DoF) or 6DoF head tracking, location (space or environment) recognition, and/or movement recognition. In an embodiment, the camera modules 311 and 312 may be used for hand detection and tracking or recognition or detection of the user's gesture.

In an embodiment, the depth sensor 317 may be configured to transmit a signal and receive a signal reflected from an object and be used for identifying the distance to the object, such as time of flight (TOF). Alternatively or additionally to the depth sensor 317, the camera modules 313, 314, 315, and 316 may identify the distance to the object.

According to an embodiment, camera modules 325 and 326 for face recognition and/or a display 331 (and/or lens) may be disposed on the second surface 320 of the housing.

In an embodiment, the face recognition camera modules 325 and 326 adjacent to the display may be used for recognizing the user's face or may recognize and/or track both eyes of the user.

In an embodiment, the display 331 (and/or lens) may be disposed on the second surface 320 of the wearable electronic device 300. In an embodiment, the display 331 (and/or lens) may be at least partially similar to or substantially the same as the display D (and/or the lenses L1, L2, L3, and L4) of FIG. 2. In an embodiment, the wearable electronic device 300 may not include the camera modules 315 and 316 among the plurality of camera modules 313, 314, 315, and 316. The wearable electronic device 300 may further include at least one of the components shown in FIGS. 1 and/or 2.

In an embodiment, the display 331 may be understood as including a display module (e.g., the display module 160 of FIG. 1) outputting a screen and a lens assembly focusing the output screen to a user's eyes. In FIG. 3B, it is noted that in the structure of the display 331, a reference number is allocated to a portion visible on an exterior of the wearable electronic device 300, and the reference number is indicated on a lens closest to the user's eyes.

As described above, according to an embodiment, the wearable electronic device 300 may have a form factor to be worn on the user's head. The wearable electronic device 300 may further include a strap and/or a wearing member to be fixed on the user's body part. The wearable electronic device 300 may provide the user experience based on augmented reality, virtual reality, and/or mixed reality while worn on the user's head.

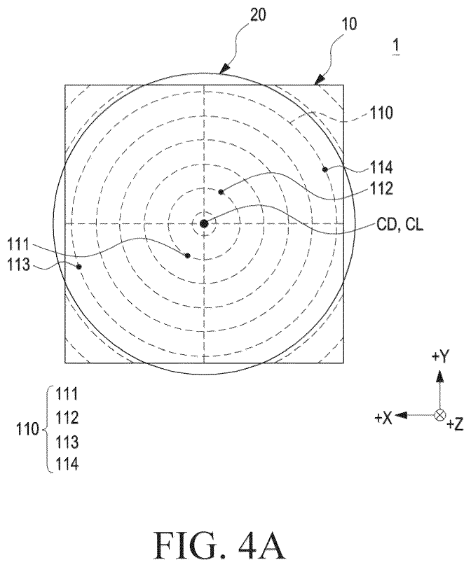

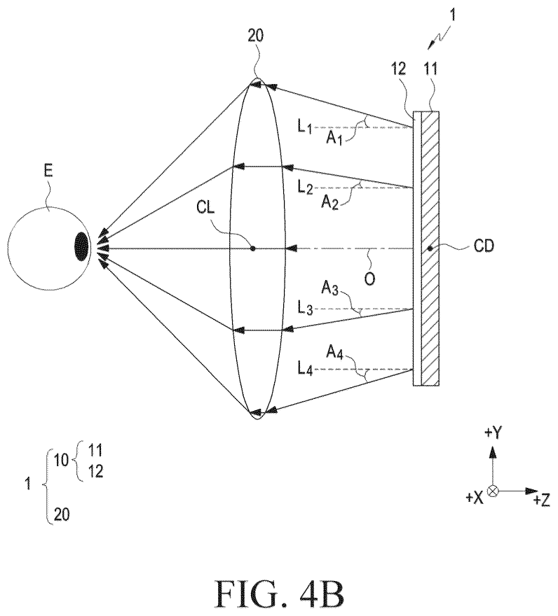

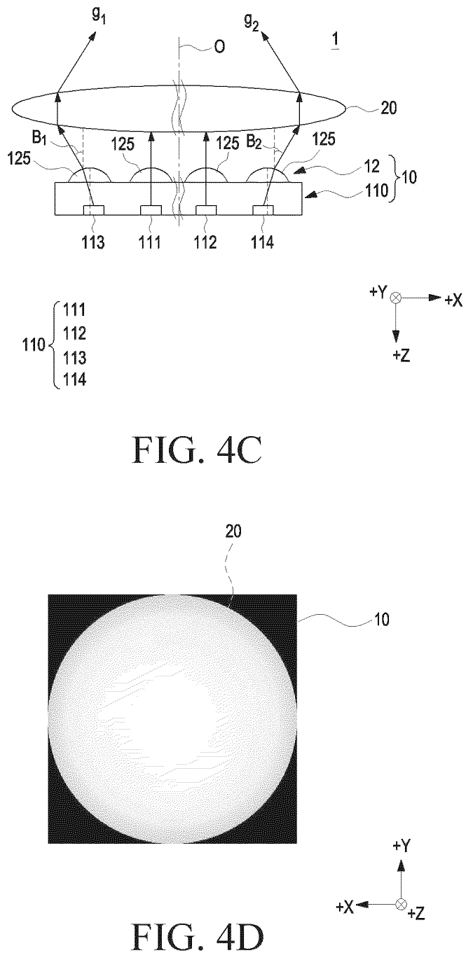

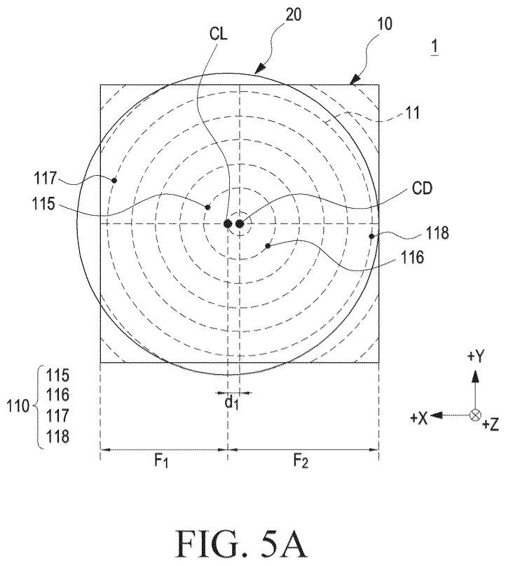

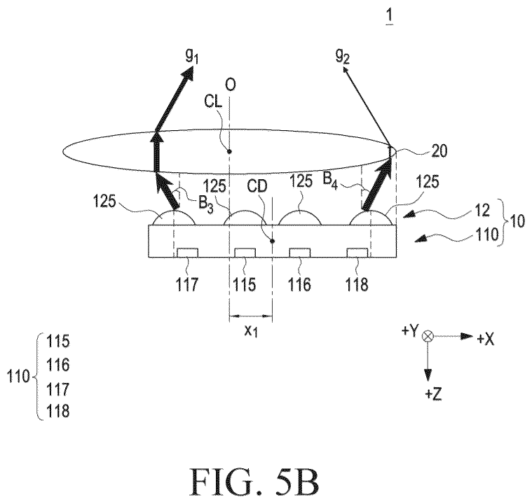

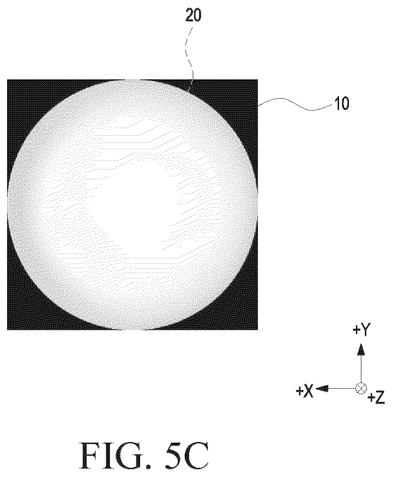

FIG. 4A is a schematic plan view illustrating arrangement of a display and a lens of a display assembly according to an embodiment of the disclosure. FIG. 4B is a schematic side view illustrating an arrangement relationship between a display and a lens and a movement path of light according to an embodiment of the disclosure. FIG. 4C is a schematic cross-sectional side view illustrating an arrangement relationship between a display and a lens and a movement path of light according to an embodiment of the disclosure. FIG. 4D is a simulation image of a field of view provided by the display assembly of FIGS. 4A to 4C according to an embodiment of the disclosure. FIG. 5A is a schematic plan view illustrating arrangement of a display and a lens of a display assembly according to an embodiment of the disclosure. FIG. 5B is a schematic cross-sectional side view illustrating an arrangement relationship between a display and a lens and a movement path of light according to an embodiment of the disclosure. FIG. 5C is a simulation image of a field of view provided by the display assembly of FIGS. 5A and 5B according to an embodiment of the disclosure. FIGS. 4A to 5C may show a display 10 and a lens 20 as comparative examples for describing the display 601 and the lens 603 according to embodiments of FIGS. 6 to 7 and FIGS. 9 to 11.

Referring to FIGS. 4A and 5A, a display assembly 1 may include a display 10 (e.g., the light output module 211 of FIGS. 3A and 3B) and a lens 20 (e.g., the display member 201 of FIGS. 2 to 3). The display assembly 1 may be included in a wearable electronic device (e.g., the electronic device 101 of FIG. 1, the wearable electronic device 200 of FIG. 2, and/or the wearable electronic device 300 of FIGS. 3A and 3B), such as a head-mounted device (HMD) or smart glasses. The display assembly 1 may be configured to provide and transmit an image to a user's eyes (e.g., retina). For example, the configuration of the display 10 of the embodiment of FIGS. 4A to 5B may be identical or similar to all or some of the configuration of the display D of FIG. 2 and/or the display 331 of FIG. 3B. For example, the lens 20 of the embodiment of FIGS. 4A to 5B may be a lens (e.g., a pancake lens) (or lens assembly) including a plurality of lenses (e.g., the lenses L1, L2, L3, L4 of FIG. 2).

Referring to FIGS. 4A and 5A, e.g., the display 10 may include a display panel 11 and an optical assembly 12 (e.g., a micro-lens array) stacked on the display panel 11. The display panel 11 may include pixels 110 that are light emitting elements. The optical assembly 12 may include micro-lenses 125 for transmitting and/or refracting light output from each pixel 110 of the display panel 11 to guide the light to the lens 20. According to an embodiment, the optical assembly 12 may be integrated into the display panel 11 as portion of the display panel 11. For example, the optical assembly 12 may be provided in the form in which an optical structure (e.g., a lens structure or an uneven structure) configured to transmit and/or refract light output from the pixels 110 is patterned on a layer on which the pixels 110 are disposed. For example, the lens 20 may be disposed between a user's eyes (e.g., retina) and the display 10.

Referring to FIGS. 4A to 4D, in an embodiment, the center CD of the display 10 and the center CL of the lens 20 may overlap or be aligned in a thickness direction of the member (e.g., Z-axis direction). Referring to FIGS. 5A to 5C, in an embodiment, the center CL of the lens 20 may be spaced apart or offset from the center CD of the display 10 in a horizontal direction (e.g., X-axis direction). Referring to FIGS. 5A and 5B, according to an embodiment, the center CL of the lens 20 may be spaced apart or offset from the center CD of the display 10 to the right (e.g., +X direction) by a designated interval (e.g., d1 of FIGS. 5A and 5B). For example, in other words, referring to FIG. 5A, the center CD of the display 10 and the center CL of the lens 20 may not overlap or be aligned in the thickness direction of the member (e.g., Z-axis direction).

For example, the display 10 and the lens 20 of FIG. 5A may be disposed to provide or transmit light to a user's right eye, and the lens 20 of FIG. 5A may be in a state of being spaced apart to the left (e.g., −X direction) with respect to the display 10. For example, when the center CL of the lens 20 is spaced apart or offset in a specific direction (e.g., left or −X direction) with respect to the center CD of the display 10 (e.g., FIG. 5A), compared to a case where the center CD of the display 10 and the center CL of the lens 20 overlap or are aligned in the thickness direction of the member (e.g., Z-axis direction) (e.g., FIG. 4A), a horizontal viewing angle may be larger, and a viewing angle relatively closer to a user's naked eye or actual viewing angle may be implemented. Here, “horizontal viewing angle” may mean a viewing angle in a horizontal direction parallel to a left-right direction (e.g., X-axis direction). For example, in FIG. 6, an angle F1 of a first portion may be about 45 degrees or more and an angle F2 of a second portion may be about 50 degrees or more, and a horizontal viewing angle over the two portions F1 and F2 may be about 100 degrees or more.

When the center CL of the lens 20 is designed to be spaced apart from the center CD of the display 10 as illustrated in FIG. 5A, a color fringing phenomenon may occur or increase compared to a case where the center CD of the display 10 and the center CL of the lens 20 are designed to be aligned in the thickness direction of the member (e.g., Z-axis direction) as illustrated in FIG. 4A. FIG. 4C may be a simulation image of a field of view provided by the display assembly 1 of FIGS. 4A and 4B, respectively. FIG. 4D is a simulation image provided by the display assembly 1 according to the embodiment of FIGS. 4A to 4C, and FIG. 5C may be a simulation image of a field of view provided by the display assembly 1 according to the embodiment of FIGS. 5A and 5B, respectively. FIG. 5C may show a simulation image in which a color fringing phenomenon is increased compared to the simulation image of FIG. 4D.

Referring to FIGS. 4A and 4B, the display 10 (e.g., a display panel) may include a plurality of continuously disposed pixel(s) 110. Pixels disposed at arbitrary positions on the display 10 (e.g., a display panel) may be indicated by reference numerals 111, 112, 113, and 114 in FIGS. 4A and 4B. For example, the pixels 111 and 112 and the micro-lenses 125 transmitting light output from the pixels 111 and 112 to the lens 20 may be disposed in an area around the center CD of the display 10 or an area adjacent to the center CD (e.g., the first display area 601a of FIG. 6). For example, the pixels 113 and 114 and the micro-lenses 125 transmitting light output from the pixels 113 and 114 to the lens 20 may be disposed in an edge area or an outermost area of the display 10 (e.g., the second display area 601b of FIG. 6). For example, the pixels 113 and 114 may be disposed farther from the center CD of the display 10 and closer to an edge of the display 10 compared to the other pixels 111 and 112.

Referring to FIGS. 5A and 5B, the display panel 11 of the display 10 may include pixels 110 that are light emitting elements continuously disposed on one plane (e.g., X-Y plane). For example, pixels disposed at arbitrary positions on the display panel 11 may be indicated by reference numerals 115, 116, 117, and 118 in FIGS. 5A and 5B. For example, the pixels 115 and 116 and the micro-lenses 125 transmitting light output from the pixels 115 and 116 to the lens 20 may be disposed in an area around the center CD of the display 10 or an area adjacent to the center CD (e.g., the first display area 601a of FIG. 6). For example, the pixels 117 and 118 and the micro-lenses 125 transmitting light output from the pixels 117 and 118 to the lens 20 may be disposed in an edge area or an outermost area of the display 10 (e.g., the second display area 601b of FIG. 6). For example, the pixels 117 and 118 may be disposed farther from the center CD of the display 10 and closer to an edge of the display 10 compared to the other pixels 115 and 116.

Referring to FIG. 4B, e.g., the pixels 110 of the display panel 11 may each have “chief ray angles” (e.g., A1, A2, A3, A4 of FIG. 4B) that are corresponding or changed according to positions on the display 10 (e.g., the display panel 11). In the disclosure, “chief ray angle” may refer to an angle formed by a path directing toward a predetermined or designed position (or “incident position”) where light output from each pixel 110 of the display panel is incident on the lens 20 with respect to the optical axis O or a virtual axis parallel to the optical axis O (e.g., L₁, L₂, L₃, L₄ of FIG. 4B). For example, the chief ray angle may be an angle formed by a chief ray between an upper ray and a lower ray among a bundle of rays output from each pixel 110 with respect to the optical axis O. For example, the “incident position” and the value of the “chief ray angle” may correspond to positions of each pixel 110 on the display 10 (e.g., the display panel 11), and may vary according to the positions of each pixel 110. For example, the “incident position” and the “chief ray angle” may be preset or designed to increase or optimize light efficiency transmitted from the display panel 11 and transmitted to the lens 20.

For example, the chief ray angles of the pixels 110 may increase as they are disposed farther from the center CD of the display 10 or closer to an edge of the display 10. For example, when a pixel 110 aligned with the center CL of the lens in a thickness direction of the member (e.g., Z-axis direction) is present, the chief ray angle of the pixel 110 may be 0 degrees. Referring to FIG. 4B, e.g., the chief ray angles of the pixels 113 and 114, which are disposed relatively farther from the center CD of the display 10 and relatively closer to an edge of the display 10 compared to the pixels 111 and 112, may be smaller than the chief ray angles of the pixels 111 and 112. In this case, compared to a case where all the pixels 110 are set to have substantially the same chief ray angle (e.g., 0 degrees) regardless of position, light output from the display panel 11 may be evenly distributed from the center CL of the lens 20 to an edge of the lens 20, so that light efficiency of the display assembly 1 may be enhanced.

The contents regarding the chief ray angles described above with reference to FIG. 4B may be equally applied to the embodiment of FIGS. 5A to 5C.

Referring to FIGS. 4C and 5B, a “compensation angle” (or refraction angle) of the micro-lens 125 (or by the micro-lens 125) may refer to an angle formed by a path of light emitted from the micro-lens 125 with respect to the optical axis O. For example, the “compensation angle” of the micro-lens 125 may be indicated by B₁, B₂ in FIG. 4C or by B₃, B₄ in FIG. 5B. The “compensation angle” of the micro-lens 125 may change light output from the pixel 110 to be identical or similar to the “chief ray angle” of the pixel 110. For example, one micro-lens 125 may correspond to one pixel 110, and the value of the compensation angle of the micro-lens 125 may be changed according to an arrangement relationship with the pixel 110 to which the micro-lens 125 corresponds.

For example, when an arbitrary micro-lens 125 is disposed to be aligned with a pixel (e.g., the pixels 111 and 112 of FIG. 4B or the pixels 115 and 116 of FIG. 5B) in a thickness direction of the member (e.g., Z-axis direction), the “compensation angle” by the arbitrary micro-lens 125 may be 0. For example, an arbitrary micro-lens 125 may be spaced apart or offset so as not to be aligned with a pixel (e.g., the pixels 113 and 114 of FIG. 4B or the pixels 117 and 118 of FIG. 5B) in a thickness direction of the member (e.g., Z-axis direction), and may change a path of light output from the pixel by a “compensation angle” to change it to be identical or similar to a “chief ray angle.” For example, the lens 20 may have a symmetrical circular shape when viewed in an optical axis O direction (e.g., Z-axis direction). For example, referring to FIGS. 4A and 5A, which are plan views when viewing the lens 20 in the optical axis O direction (e.g., Z-axis direction), the “compensation angle” and/or “chief ray angle” of pixels (111 and 112 of FIG. 4A, 113 and 114 of FIG. 4A, and 117 and 118 of FIG. 5A) disposed on the same concentric circle indicated by a dashed line may be constant.

For example, the closer an “error amount (or error),” which is a difference between the “compensation angle” and the “chief ray angle” described above, is to 0 degrees, the more a low luminance phenomenon and/or a color fringing phenomenon may be decreased. For example, when the center CL of the lens 20 is designed to be spaced apart or offset in a horizontal direction (e.g., X-axis direction) with respect to the center CD of the display 10 (or “horizontal direction offset”) as illustrated in FIG. 5A, compared to a case where the center CD of the display 10 and the center CL of the lens 20 are designed to be aligned in a thickness direction of the member (e.g., Z-axis direction) as illustrated in FIG. 4A, it may be difficult to design and manufacture the “error amount” to be substantially 0 degrees. For example, when the center CL of the lens 20 is designed to be spaced apart or offset with respect to the center CD of the display 10 as illustrated in FIG. 5A, it may be difficult to completely eliminate such error amount by a method of adjusting positions of all micro-lenses 125 on the display panel 11 (e.g., micro-lens array shifting). When the center CL of the lens 20 is designed to be spaced apart or offset with respect to the center CD of the display 10 as illustrated in FIG. 5A, a difference between the “error amount” (or first error amount) by pixels and micro-lenses disposed in a left edge area (or first edge area) of the display panel 11 and the “error amount” (or second error amount) by the pixels 110 and the micro-lenses 120 disposed in a right edge area (or second edge area) of the display panel 11 may increase, and in this case, a low luminance phenomenon and a color fringing phenomenon may be worsened.

The thickness of arrows indicating paths of light g1 and g2 in FIGS. 4C and 5B may be represented in proportion to intensity or amount of light g1 and g2. Referring to FIG. 4C, when the center CD of the display 10 and the center CL of the lens 20 are aligned in a thickness direction of the member (e.g., Z-axis direction), intensity or amount of light transmitted and refracted to a right edge (e.g., a second direction or +X direction) of the lens 20 may be similar or the same. On the other hand, e.g., referring to FIG. 5B, when the center CL of the lens 20 is spaced apart or offset from the center CD of the display 10 to the left (e.g., a first direction or −X direction) by a designated interval (d1 of FIG. 5B), intensity or amount of light g2 transmitted and refracted to a right edge (e.g., a second direction or +X direction) of the lens 20 may be smaller than intensity or amount of light g1 transmitted and refracted to a left edge (e.g., a first direction or −X direction). In the embodiment of FIG. 5B, loss of light transmitted and refracted to a right edge (e.g., a second direction or +X direction) of the lens 20 may increase, and light efficiency of the display assembly 1 may be degraded. In the disclosure, when the error amount of the display assembly 1 is decreased, light efficiency of the display assembly 1 may be enhanced, and conversely, when the light efficiency of the display assembly 1 is enhanced, the error amount of the display assembly 1 may be decreased.

According to an embodiment of the disclosure to be described below with reference to FIGS. 6 to 11, a wearable electronic device (e.g., the electronic device 101 of FIG. 1, the wearable electronic device 200 of FIG. 2, and/or the wearable electronic device 300 of FIGS. 3A and 3B) including a display assembly 600 in which the center CL of the lens 603 is spaced apart or offset with respect to the center CD of the display 601 to have a wide viewing angle may be provided. The display assembly 600 may be adjusted so that error amounts (difference values between chief ray angles and compensation angles) respectively corresponding to a left edge area (e.g., −X direction or first direction) and a right edge area (e.g., +X direction or second direction) of the display 601 are similar to each other, and accordingly, a low luminance phenomenon and a color fringing phenomenon due to horizontal direction offset may be suppressed or enhanced.

In the disclosure, “left (or left direction)” may be referred to as a “first direction” and may mean a −X direction based on FIGS. 2 to 9. In the disclosure, “right (or right direction)” may be referred to as a “second direction” and may mean a +X direction based on FIGS. 2 to 9.

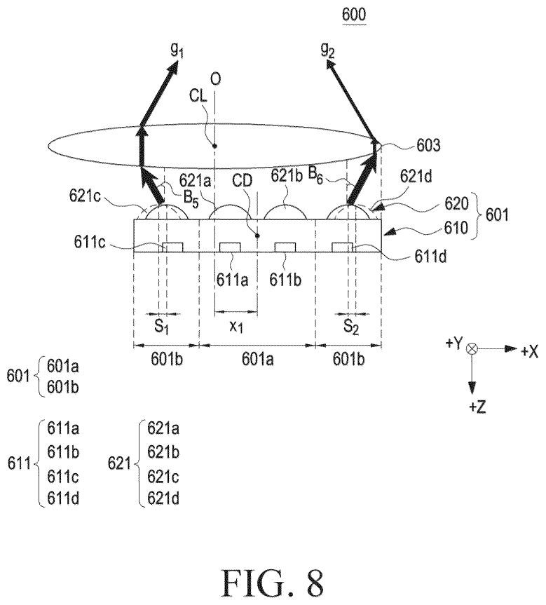

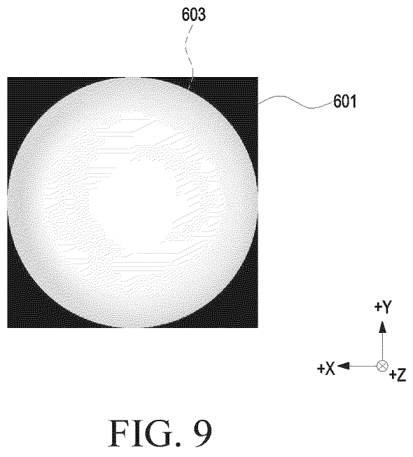

FIG. 6 is a schematic plan view illustrating arrangement of a display and a lens of a light output device according to an embodiment of the disclosure. FIG. 7 is a schematic side view illustrating an arrangement relationship between a display and a lens and a movement path of light according to an embodiment of the disclosure. FIG. 8 is a schematic cross-sectional side view illustrating an arrangement relationship between a display and a lens and a movement path of light according to an embodiment of the disclosure. FIG. 9 is a simulation image of a field of view provided by the light output device of FIGS. 6 to 8 according to an embodiment of the disclosure.

As is described below with reference to FIGS. 6 to 9, the display assembly 600 may include micro-lenses (e.g., micro-lens(es) 621 of FIG. 8) having positions moved on one plane (e.g., a plane perpendicular to the optical axis O or a plane parallel to an X-Y plane) to enhance a low luminance phenomenon and a color fringing phenomenon caused by the center CL of the lens 20; 603 being offset with respect to the center CD of the display 10; 601 in an example of the display assembly 1 described above with reference to FIGS. 5A to 5C.

According to an embodiment, a display assembly 600 may include a display 601 (or first display) (e.g., the light output module 211 of FIGS. 3A and 3B) and a lens 603 (or first lens) (e.g., the display member 201 of FIGS. 2 to 3B). The display assembly 600 may be included in a wearable electronic device (e.g., the electronic device 101 of FIG. 1, the wearable electronic device 200 of FIG. 2, and/or the wearable electronic device 300 of FIGS. 3A and 3B), such as a head-mounted device (HMD) or smart glasses. According to an embodiment, the configuration of the display 601 of the embodiment of FIGS. 6 to 9 may be identical or similar to all or some of the configuration of the display D of FIG. 2 and/or the display 331 of FIG. 3B. For example, the lens 20 of the embodiment of FIGS. 6 to 9 may be a lens (e.g., a pancake lens) (or lens assembly) including a plurality of lenses (e.g., the lenses L1, L2, L3, L4 of FIG. 2).

According to an embodiment, a wearable electronic device (e.g., the electronic device 101 of FIG. 1, the wearable electronic device 200 of FIG. 2, and/or the wearable electronic device 300 of FIGS. 3A and 3B) may include a pair of display assemblies 600 corresponding to a user's left eye and right eye. In the disclosure, the display assembly 600 (e.g., the display 331 of FIG. 3B) corresponding to a user's right eye may be exemplified and described. According to an embodiment, a wearable electronic device (e.g., the electronic device 101 of FIG. 1, the wearable electronic device 200 of FIG. 2, and/or the wearable electronic device 300 of FIGS. 3A and 3B) may further include a display assembly that is a mirror image of the display assembly 600 with respect to the Y axis as a display assembly corresponding to a user's left eye. The display assembly corresponding to a user's left eye may include the structure and features of the display assembly 600 to be described below, and may not be separately described.

Referring to FIG. 6, the display 601 (e.g., the light output module 211 of FIGS. 3A and 3B) may include a first display area 601a disposed around the center CD of the display 601 and a second display area 601b disposed around the first display area 601a. For example, the first display area 601a is an area around the center CD of the display 601, and the second display area 601b may be an area from an edge of the first display area 601a to an outermost edge or edge of the display 601. For example, the second display area 601b may be a shaded area in FIG. 6 or may be an area smaller or larger than the shaded area. For example, an area of the second display area 601b may be about 5% to about 15% of a total area of the display 601, and as an example, about 10%.

According to an embodiment, the lens 603 (e.g., the display member 201 of FIGS. 2 to 3B) may be configured to transmit light or an image output from the display 601 to a user's eyes (e.g., E of FIG. 7). An optical axis O of the lens 603 may be perpendicular to a plane parallel to the display panel 610 (e.g., an X-Y plane).

Referring to FIGS. 6 and 8, according to an embodiment, the center CL of the lens 603 may be spaced apart or offset from the center CD of the display 601 in a first direction (e.g., left direction or −X direction) by a designated interval x1. For example, when the center CL of the lens 603 is offset in a specific direction (e.g., a first direction) with respect to the center CD of the display 601 (e.g., FIGS. 5A and 6), compared to a case where the center CD of the display 601 and the center CL of the lens 603 overlap or are aligned in a thickness direction of the member (e.g., Z-axis direction) (e.g., FIG. 4A), a horizontal viewing angle may be larger, and a viewing angle relatively closer to a user's naked eye or actual viewing angle may be implemented. Here, “horizontal viewing angle” may mean a viewing angle in a horizontal direction parallel to a left-right direction (e.g., X-axis direction). For example, in FIG. 6, an angle F1 of a first portion may be about 45 degrees or more and an angle F2 of a second portion may be about 50 degrees or more, and a horizontal viewing angle over the two portions F1 and F2 may be about 100 degrees or more.

The display assembly 600 according to the embodiment of FIGS. 6 to 8 may include micro-lenses 621 having positions moved on one plane (e.g., an X-Y plane) to enhance a low luminance phenomenon and/or a color fringing phenomenon caused by the center CL of the lens 20; 603 being offset with respect to the center CD of the display 10; 601, like the display assembly 1 described above with reference to FIGS. 5A to 5C. According to an embodiment, the micro-lenses 621 having positions moved on one plane (e.g., an X-Y plane) may be disposed in a left or right edge area (e.g., the second display area 601b of FIG. 6) of the display 601. FIG. 9 may be an image simulating a field of view provided to a user using the display assembly 600 according to the embodiment of FIGS. 6 to 8. The simulation image of FIG. 9 may show that a color fringing phenomenon is decreased compared to the simulation image of FIG. 5C.

Referring to FIGS. 6 to 8, according to an embodiment, the display 601 (or first display) may include a display panel (or first display panel) 610 and an optical assembly (or first optical assembly) 620.

Referring to FIG. 6, according to an embodiment, the display panel 610 may include pixels (or first pixels) 611 that are light emitting elements continuously disposed on one plane (e.g., an X-Y plane). Referring to FIG. 6, e.g., pixels disposed at arbitrary positions on the display panel 610 may be indicated by 611a, 611b, 611c, and 611d in FIGS. 6 and 8.

According to an embodiment, the optical assembly 620 may be stacked or disposed on a surface (e.g., a rear surface or −Z direction surface) of the first display panel 610. According to an embodiment, the first optical assembly 620 may include micro-lenses 621 formed to guide light output from the pixels 611 of the display panel 610 to the lens 603. The micro-lenses 621 may transmit and/or refract light output from the pixels 611. According to an embodiment, the optical assembly 620 may be integrated into the display panel 610 as portion of the display panel 610. For example, the optical assembly 620 may be provided in the form in which an optical structure (e.g., a lens structure or an uneven structure) configured to transmit and/or refract light output from the pixels 611 is patterned on a layer on which the pixels 611 are disposed.

Referring to FIG. 7, e.g., the pixels 611 may each have a “chief ray angle” (e.g., A1, A2, A3, A4 of FIG. 7) that is changed according to a position on the display 601 (e.g., the display panel 610). In the disclosure, “chief ray angle” may refer to an angle formed by a path directing toward a predetermined or designed position (or “incident position”) where light output from each pixel 611 of the display panel is incident on the lens 603 with respect to the optical axis O or a virtual axis parallel to the optical axis O (e.g., L₁, L₂, L₃, L₄ of FIG. 7). For example, the chief ray angle may be an angle formed by a chief ray between an upper ray and a lower ray among a bundle of rays output from each pixel 611 with respect to the optical axis O. For example, the “incident position” and the value of the “chief ray angle” may correspond to positions of each pixel 611 on the display 601 (e.g., the display panel 610), and may vary according to the positions of each pixel 611. For example, the “incident position” and the “chief ray angle” may be preset or designed to increase or optimize light efficiency transmitted from the display panel 610 and transmitted to the lens 603.

For example, the chief ray angles of the pixels 611 may increase as they are disposed farther from the center CD of the display 10 or closer to an edge of the display 10. For example, when a pixel aligned with the center CL of the lens in a thickness direction of the member (e.g., Z-axis direction) is present, the chief ray angle of the pixel may be 0. Referring to FIG. 7, e.g., the chief ray angles of the pixels 611c and 611d, which are disposed relatively farther from the center CD of the display 10 and relatively closer to an edge of the display 10 compared to the pixels 611a and 611b, may be smaller than the chief ray angles of the pixels 611a and 611b. In this case, compared to a case where all the pixels 611 are set to have substantially the same chief ray angle (e.g., 0 degrees) regardless of position, light output from the display panel 601 may be evenly distributed from the center CL of the lens 603 to an edge of the lens 603, so that light efficiency of the display assembly 600 may be enhanced.

Referring to FIG. 8, a “compensation angle” (or compensation angle or refraction angle) of the micro-lens 621 (or by the micro-lens 621) may refer to an angle formed by a path of light passing through the micro-lens 621 with respect to the optical axis O. For example, the “compensation angle” of the micro-lens 621 may be indicated by B₅ and B₆ in FIG. 8. The “compensation angle” of the micro-lens 621 may change light output from the pixel 611 to be identical or similar to the “chief ray angle” of the pixel 611. For example, one micro-lens 621 may correspond to one pixel 611, and the value of the “compensation angle” may be changed according to an arrangement relationship between the micro-lens 621 and the corresponding pixel 611.

Referring to FIG. 8, e.g., the pixels 611a and 611b and the micro-lenses 621a and 621b respectively transmitting light output from the pixels 611a and 611b to the lens 603 may be disposed in the first display area 601a of the display 601. For example, the pixels 611c and 611d and the micro-lenses 621c and 621d respectively transmitting light output from the pixels 611c and 611d to the lens 603 may be disposed in the second display area 601b of the display 10. For example, the micro-lens 621c disposed in the second display area 601b may refract light output from the pixel 611c by a compensation angle B₅ to transmit the light to the lens 603. For example, the micro-lens 621d disposed in the second display area 601b may refract light output from the pixel 611d by a compensation angle B₆ to transmit the light to the lens 603.

For example, the closer an “error amount (or error),” which is a difference between the “compensation angle” and the “chief ray angle” described above, is to 0 degrees, the more a low luminance phenomenon and/or a color fringing phenomenon may be decreased. For example, when the center CL of the lens 603 is designed to be spaced apart or offset in a horizontal direction (e.g., X-axis direction) with respect to the center CD of the display 601 as in the embodiment of FIGS. 6 to 8 (or “horizontal direction offset”), it may be difficult to design and manufacture the “error amount” to be substantially 0 degrees. For example, when the center CL of the lens 603 is designed to be spaced apart or offset with respect to the center CD of the display 601 as in the embodiment of FIGS. 6 to 8, it may be difficult to completely eliminate such error by a method of adjusting positions of all micro-lenses 621 on the display panel 610 (e.g., micro-lens array shifting).

In particular, a difference between the “error amount” (or “first error amount”) by pixels (e.g., 611d of FIG. 8) and micro-lenses (e.g., 621d of FIG. 8) disposed in a left (e.g., first direction or −X direction) edge area (or first edge area) of the second display area 601b of the display panel 610 and the “error amount” (or “second error amount”) by pixels (e.g., 611c of FIG. 8) and micro-lenses (e.g., 621c of FIG. 8) disposed in a right (e.g., second direction or +X direction) edge area (or second edge area) of the second display area 601b increases, a low luminance phenomenon and a color fringing phenomenon of the display assembly 600 may be worsened.

According to an embodiment, positions of the micro-lenses 621 disposed in a portion of the second display area 601b may be adjusted or determined on a plane of the display panel 610 (e.g., an X-Y plane) to reduce a difference between the “first error amount” and the “second error amount.” Referring to FIGS. 5B and 8 together, as described above, the lens 20 of FIG. 5B and the lens 603 of FIG. 8 may be in a state of being spaced apart or offset from the display 10 or 610 in a first direction (e.g., left direction or −X direction) by a designated interval (e.g., d1 of FIG. 5B or x1 of FIG. 8) to extend a horizontal viewing angle. According to an embodiment, the micro-lenses 621c and 621d disposed in the second display area 601b may be in a state of being moved diagonally on a plane of the display panel 610 (e.g., an X-Y plane) compared to the corresponding micro-lenses 120 of FIG. 5B.

The thickness of arrows indicating paths of light g1 and g2 in FIG. 8 may be represented in proportion to intensity or amount of light g1 and g2. Referring to FIG. 8, among the micro-lenses 621c and 621d disposed in the second display area 601b, a right micro-lens 621c outputting light to a right edge (e.g., a second direction or +X direction) of the lens 603 may be moved so that intensity or amount of light g1 is decreased, and for example, the right micro-lens 621c may be moved to the right (e.g., a second direction or +X direction) by a first movement distance S₁. A left micro-lens 621d outputting light to a left edge (e.g., a first direction or −X direction) of the lens 603 may be moved so that intensity or amount of light g2 is increased, and for example, may be moved to the left (e.g., a first direction or −X direction) by a second movement distance S₂. For example, the first movement distance S₁ and the second movement distance S₂ may be different from each other or may be similar or substantially the same as each other.

According to the embodiment of FIG. 8, compared to the embodiment of FIG. 5B, a difference between intensity or amount of light g2 transmitted and refracted to a left edge (e.g., a first direction or −X direction) of the lens 603; 20 and intensity or amount of light g1 transmitted and refracted to a right edge (e.g., a second direction or +X direction) of the lens 603; 20 may be decreased. In the embodiment of FIG. 8, compared to the embodiment of FIG. 5B, loss of light g2 transmitted and refracted to a left edge (e.g., a first direction or −X direction) of the lens 603 may be decreased, and overall light efficiency of the display assembly 600 may be increased or enhanced. In the disclosure, when the error amount of the display assembly 600 is decreased, light efficiency of the display assembly 600 may be enhanced, and conversely, when the light efficiency of the display assembly 600 is enhanced, the error amount of the display assembly 600 may be decreased.

For example, the micro-lenses 621c and 621d may have the same displacement in a left-right direction (e.g., X-axis direction) and displacement in an up-down direction (e.g., Y-axis direction) on a plane of the display panel 610 (e.g., an X-Y plane) with respect to the corresponding micro-lenses 120 of FIG. 5B.

The micro-lenses 621c and 621d disposed in the second display area 601b in FIG. 8 may be in a state of being disposed closer toward the center (e.g., CD of FIG. 6) of the display or the first display area 601a compared to the corresponding micro-lenses 120 of FIG. 5B. By the arrangement of the micro-lenses 621c and 621d in FIG. 8, an error amount, which is a difference between the compensation angles B₅ and B₆ and the chief ray angles of each pixel 611c and 611d, may be decreased.

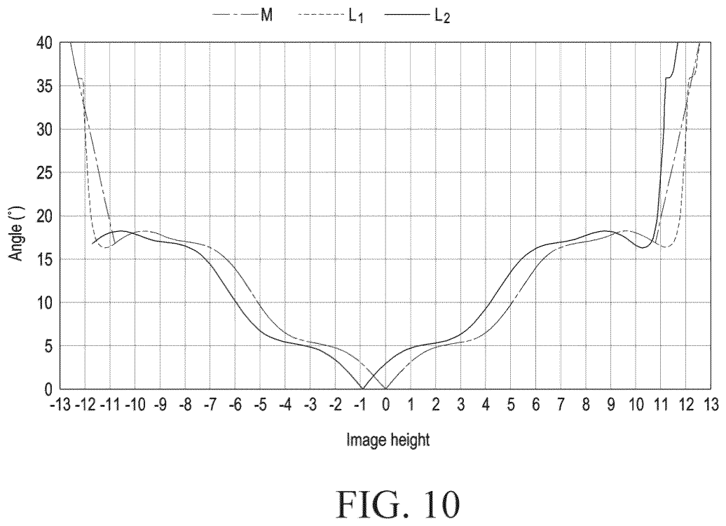

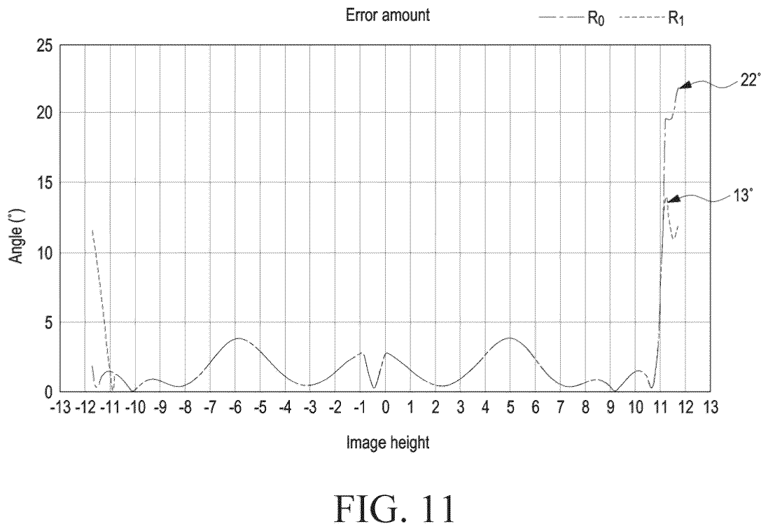

FIG. 10 is a graph illustrating changes in chief ray angles and compensation angles of a display assembly according to an embodiment. FIG. 11 is a graph illustrating changes in error amounts between chief ray angles and compensation angles of a display assembly according to an embodiment.

The horizontal axis of FIGS. 10 and 11 may represent a position in a left-right direction (e.g., X-axis direction) on the display 601 or the display panel 610, and for example, 0 may represent a position aligned in an up-down direction (e.g., Y-axis direction) with the center CD of the display 601, and as it goes from 0 to 13, it becomes closer to a right direction (e.g., +X direction) edge of the display 601, and as it goes from 0 to −13, it may become closer to a left direction (e.g., −X direction) edge of the display 601. The vertical axis of FIGS. 10 and 11 may represent angle values of the chief ray angle, the compensation angle, and the error amount.

A graph M of FIG. 10 may represent the chief ray angle by the display assembly 600 described above with reference to FIGS. 6 to 9. A graph L₁ of FIG. 10 may represent the compensation angle by the display assembly 1 described above with reference to FIGS. 5A to 5C. A graph L₂ of FIG. 10 may represent the compensation angle by the display assembly 600 described above with reference to FIGS. 6 to 9.

A graph R₀ of FIG. 11 may represent an error amount, which is a difference between the chief ray angle and the compensation angle by the display assembly 1 described above with reference to FIGS. 5A to 5C. In other words, the graph R₀ may represent a difference value between the graph M and the graph L₁ of FIG. 10. A graph R₁ of FIG. 11 may represent an error amount, which is a difference between the chief ray angle and the compensation angle by the display assembly 600 described above with reference to FIGS. 6 to 9. In other words, the graph R₁ may represent a difference value between the graph M and the graph L₂ of FIG. 10.

Referring to FIG. 11, a maximum value of the error amount of the graph L₁ may be about 22 degrees, and a maximum value of the error amount of the graph L₂ may be about 13 degrees. According to an embodiment, the maximum values of the error amount may occur at a right direction (e.g., +X direction) edge of the second display area 601b of the display 10; 601. According to an embodiment, a difference between an error amount (or first error amount) at a left direction (e.g., −X direction) edge (or first edge) of the second display area 601b and an error amount (or second error amount) at a right direction (e.g., +X direction) edge (or second edge) may be included within a first designated range. For example, an upper limit of the first designated range may be from 9 degrees to 15 degrees, and as an example, may be about 10 degrees.

The disclosure is not limited to the foregoing embodiments but various modifications or changes may rather be made thereto without departing from the spirit and scope of the disclosure. The effects that may be obtained from this disclosure are not limited to the effects mentioned above, and various effects that may be directly or indirectly identified through the disclosure may be provided.

The optical assembly and the electronic device including the same of the disclosure described above are not limited by the embodiments and drawings described above, and it will be apparent to those skilled in the art to which the disclosure pertains that various substitutions, modifications, and changes are possible within the technical scope of the disclosure.

According to an embodiment of the disclosure, a wearable electronic device (101; 200; 300) may be provided. The wearable electronic device may include a first display 601 including a first display panel 610 and a first optical assembly 620 disposed on a surface of the first display panel, and a first lens 603 configured to transmit light output from the first display to a user's eyes. The center CL of the first lens may be spaced apart or offset from the center CD of the first display in a first direction A by a designated interval x1. The first display panel 610 includes first pixels 611 continuously disposed on a same plane, and chief ray angles with respect to an optical axis of the first lens may change corresponding to the first pixels. The first optical assembly 620 may include first micro-lenses 621 configured to change paths of light output from the first pixels 611 by compensation angles to provide the light output from the first pixels 611 to the first lens 603. Difference values between first error amounts, which are differences between the chief ray angles and the compensation angles in a first edge area of the first display located in the first direction, and second error amounts, which are differences between the chief ray angles and the compensation angles in a second edge area of the first display located in a second direction opposite to the first direction, may be set to be included within a first designated angle range.

According to an embodiment, an upper limit of the first designated angle range may be from 9 degrees to 15 degrees.

According to an embodiment, the first display may include a first display area 601a corresponding to a central portion of the first display and a second display area 601b disposed around the first display area.

According to an embodiment, the second display area may include the first edge area and the second edge area of the display.

According to an embodiment, the chief ray angles of the first pixels disposed in the second display area may be greater than the chief ray angles of the first pixels disposed in the first display area.

According to an embodiment, the compensation angles of the first micro-lenses receiving light from the first pixels disposed in the second display area may be greater than the compensation angles of the first micro-lenses receiving light output from the first pixels disposed in the first display area.

According to an embodiment, the first lens may be configured to converge light transmitted through the first micro-lenses.

According to an embodiment, the wearable electronic device may further include a housing formed to support the first lens and the first display and a battery disposed within the housing and configured to supply power to the first display.

According to an embodiment, a viewing angle provided by the first lens based on a direction parallel to the first direction or the second direction may be 100 degrees or more.

According to an embodiment, the wearable electronic device may further include a second lens disposed in the first direction with respect to the first lens and a second display disposed in the first direction with respect to the first display.

The center of the second lens may be spaced apart from the center of the second display in the second direction by the designated interval x1.

According to an embodiment, a viewing angle provided by at least one of the first lens or the second lens based on a direction parallel to the first direction or the second direction may be 100 degrees or more.

According to an embodiment, the second display may include a second display panel and a second optical assembly disposed on a surface of the second display panel. The second display panel includes second pixels continuously disposed on a same plane, and chief ray angles with respect to an optical axis of the second lens may change according to positions of the second pixels. The second optical assembly may include second micro-lenses configured to change paths of light output from the second pixels by compensation angles to provide the light output from the second pixels to the second lens.

According to an embodiment, difference values between third error amounts, which are differences between the chief ray angles and the compensation angles in a third edge area of the second display located in the first direction, and fourth error amounts, which are differences between the chief ray angles and the compensation angles in a fourth edge area of the second display located in the second direction, may be set to be included within a second designated angle range.

According to an embodiment, an upper limit of the second designated angle range may be from 9 degrees to 15 degrees.

According to an embodiment of the disclosure, a display assembly 600 may be provided. The display assembly may include a display panel 610 including pixels 611 continuously disposed on a same plane, wherein chief ray angles with respect to an optical axis of the lens change according to positions of the pixels. The display assembly may include an optical assembly 620 stacked on a surface of the display panel and a lens 603 configured to transmit light transmitted through the display panel and the optical assembly to a user's eyes. The center CL of the lens may be spaced apart from the center CD of the display panel in a first direction A by a designated interval x1. The optical assembly 620 may include micro-lenses 621 configured to change paths of light output from the pixels 611 by compensation angles to provide the light output from the pixels 611 to the lens 603. Difference values between first error amounts, which are differences between the chief ray angles and the compensation angles in a first edge area of the display located in the first direction, and second error amounts, which are differences between the chief ray angles and the compensation angles in a second edge area of the display located in a second direction opposite to the first direction, may be set to be included within a first designated angle range.

According to an embodiment, an upper limit of the first designated angle range may be from 9 degrees to 15 degrees.

According to an embodiment, the display may include a first display area 601a corresponding to a central portion of the display and a second display area 601b disposed around the first display area.

According to an embodiment, the second display area may include the first edge area and the second edge area of the display.

According to an embodiment, the chief ray angles of the pixels disposed in the second display area may be greater than the chief ray angles of the pixels disposed in the first display area.

According to an embodiment, the compensation angles of the micro-lenses receiving light from the pixels disposed in the second display area may be greater than the compensation angles of the micro-lenses receiving light output from the pixels disposed in the first display area.

While the disclosure has been described and shown in connection with an embodiment, it should be appreciated that an embodiment is intended as limiting the present disclosure but as illustrative. It will be apparent to one of ordinary skill in the art that various changes may be made in form and detail without departing from the overall scope of the disclosure, including the appended claims and their equivalents.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a first display comprising a first display panel and a first optical assembly on a surface of the first display panel; and
a first lens configured to transmit light output from the first display to eyes of a user,
wherein a center of the first lens is spaced apart from a center of the first display in a first direction by a designated interval,
wherein the first display panel comprises first pixels continuously arranged on a same plane, and chief ray angles with respect to an optical axis of the first lens change corresponding to the first pixels,
wherein the first optical assembly comprises first micro-lenses configured to change paths of light output from the first pixels by compensation angles to provide the light output from the first pixels to the first lens,
wherein difference values between first error amounts, which are differences between the chief ray angles and the compensation angles in a first edge area of the first display located in the first direction, and second error amounts, which are differences between the chief ray angles and the compensation angles in a second edge area of the first display located in a second direction opposite to the first direction, are set to be within a first designated angle range.

2. The wearable electronic device of claim 1, wherein an upper limit of the first designated angle range is from 9 degrees to 15 degrees.

3. The wearable electronic device of claim 1, wherein the first display comprises:
a first display area corresponding to a central portion of the first display; and
a second display area around the first display area.

4. The wearable electronic device of claim 3, wherein the second display area comprises the first edge area and the second edge area of the display.

5. The wearable electronic device of claim 3, wherein the chief ray angles of the first pixels in the second display area are greater than the chief ray angles of the first pixels in the first display area.

6. The wearable electronic device of claim 3, wherein the compensation angles of the first micro-lenses receiving light from the first pixels in the second display area are greater than the compensation angles of the first micro-lenses receiving light output from the first pixels in the first display area.

7. The wearable electronic device of claim 1, wherein the first lens is configured to converge light transmitted through the first micro-lenses.

8. The wearable electronic device of claim 1, further comprising:
a housing formed to support the first lens and the first display; and
a battery provided within the housing and configured to supply power to the first display.

9. The wearable electronic device of claim 1, wherein a viewing angle provided by the first lens based on a direction parallel to the first direction or the second direction is at least 100 degrees.

10. The wearable electronic device of claim 1, further comprising:
a second lens disposed in the first direction with respect to the first lens; and
a second display disposed in the first direction with respect to the first display,
wherein a center of the second lens is spaced apart from a center of the second display by the designated interval in the second direction.

11. The wearable electronic device of claim 10, wherein a viewing angle provided by at least one of the first lens or the second lens based on a direction parallel to the first direction or the second direction at least 100 degrees.

12. The wearable electronic device of claim 10, wherein the second display comprises:
a second display panel;
a second optical assembly on a surface of the second display panel;
wherein the second display panel comprises second pixels continuously arranged on a same plane, and chief ray angles with respect to an optical axis of the second lens change according to positions of the second pixels, and
wherein the second optical assembly comprises second micro-lenses configured to change paths of light output from the second pixels by compensation angles to provide the light output from the second pixels to the second lens.

13. The wearable electronic device of claim 10, wherein difference values between third error amounts, which are differences between the chief ray angles and the compensation angles in a third edge area of the second display located in the first direction, and fourth error amounts, which are differences between the chief ray angles and the compensation angles in a second edge area of the second display located in the second direction, are set to be included within a second designated angle range.

14. The wearable electronic device of claim 13, wherein an upper limit of the second designated angle range is from 9 degrees to 15 degrees.

15. A display assembly comprising:
a display panel comprising pixels continuously disposed on a same plane, wherein chief ray angles with respect to an optical axis of a lens change according to positions of the pixels;
an optical assembly stacked on a surface of the display panel; and
a lens configured to transmit light transmitted through the display panel and the optical assembly to eyes of a user,
wherein a center of the lens is spaced apart from a center of the display panel in a first direction by a designated interval,
wherein the optical assembly comprises micro-lenses configured to change paths of light output from the pixels by compensation angles to provide the light output from the pixels to the lens, and
wherein difference values between first error amounts, which are differences between the chief ray angles and the compensation angles in a first edge area of the display located in the first direction, and second error amounts, which are differences between the chief ray angles and the compensation angles in a second edge area of the display located in a second direction opposite to the first direction, are set to be within a first designated angle range.

16. The display assembly of claim 15, an upper limit of the first designated angle range is from 9 degrees to 15 degrees.

17. The display assembly of claim 15, wherein the display panel comprises a first display area corresponding to a central portion of the display and a second display area around the first display area.

18. The display assembly of claim 17, wherein the second display area comprises the first edge area and the second edge area of the display.

19. The display assembly of claim 17, the chief ray angles of the pixels in the second display area are greater than the chief ray angles of the pixels in the first display area.

20. The display assembly of claim 17, wherein the compensation angles of the micro-lenses receiving light from the pixels in the second display area are greater than the compensation angles of the micro-lenses receiving light output from the pixels in the first display area.
